(19) United States
(12) Patent Application Publication
(10) Pub. No.: US 2007/0053435 A1
(43) Pub. Date: Mar. 8, 2007

(54) 3D video scalable video encoding method

(75) Inventor: Ihor Kirenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONIKLIJKE PHILIPS ELECTRONICS N.V., THE NETHERLANDS (NL)

(21) Appl. No.: 10/574,620

(22) PCT Filed: Oct. 1, 2004
(86) PCT No.: PCT/IB04/03221

§ 371 Date: Apr. 5, 2006

(30) Foreign Application Priority Data
Oct. 10, 2003 (EP) 03292521.6

(51) Int. Cl. H04B 1/66

(52) U.S. Cl. 375/240.19

(57) ABSTRACT

The present invention relates to a method of encoding a sequence of frames comprising the steps of dividing the sequence of frames into groups of N frames (F1-F8) with size H*W, one level sparial wavelet-based filtering (SF) the frames of a group to generate a first spatial subband (S1) of a first decomposition level comprising N low-low spatially filtered frames (LLs) with size H/2*W/2, doing motion estimation (ME1) on pairs of the low-low spatially filtered frames (LLS), resulting in a set of motion vector fields comprising N/2 fields, and motion-compensated temporal wavelet-based filtering (MCTF) the low-low spatially filtered frames (LLs) based on the set of motion vector fields, resulting in a first temporal subband (ST1) of a first decomposition level comprising N temporally filtered frames. The sequence comprising the spatial filtering step, the motion estimation step and the motion compensated filtering step is then iterated on frames having the lowest frequency in both temporal and spatial domains until one low-temporal frequency frame per temporal subband is left.

### FIELD OF THE INVENTION

The present invention relates to a method of and a device for encoding a sequence of frames.

This invention may be used, for example, in video compression systems adapted to generate progressively scalable (signal to noise ratio SNR, spatially or temporally) compressed video signals.

### BACKGROUND OF THE INVENTION

A conventional method for three-dimensional video scalable video encoding a sequence of frames is described, for example, in “Lifting schemes in scalable video coding”, B. Pesquet-Popescu, V. Bottreau, SCI 2001, Orlando, USA. Said method comprises the following steps illustrated in FIG. 1.

In a first step, a sequence of frames is divided into groups GOF of 2^{N} frames F1 to F8, said group having in our example 8 frames.

Then, the encoding method comprises a step of motion estimation ME based on pairs of odd Fo and even Fe input frames within the group of frames, resulting in a set MV1 of motion vector fields of a first decomposition level comprising 4 fields in the example of FIG. 1.

The motion estimation step is followed by a step of motion compensated temporal filtering MCTF, for example Haar filtering, based on the set MV1 of motion vector fields and on a lifting scheme according to which the high-frequency wavelet coefficients Ht[n] and the low-frequency coefficients Lt[n] are:
Ht[n]=Fe[n]−P(Fo[n]),
Lt[n]=Fo[n]+U(Ht[n]),

where P is a prediction function, U is an update function and n is an integer.

This temporal filtering MCTF step delivers a temporal subband T1 of a first decomposition level comprising filtered frames, which are 4 low-frequency frames Lt and 4 high-frequency frames Ht in our example.

The motion estimation and filtering steps are repeated on the low-frequency frames Lt of the temporal subband T1, that is:
motion estimation is done on pairs of odd Lto and even Lte low-frequency frames within the temporal subband T1, resulting in a set MV2 of motion vector fields of a second decomposition level comprising 2 fields in our example.
motion compensated temporal filtering based on the set MV2 of motion vector fields and on the lifting equations, and resulting in a temporal subband T2 of a second decomposition level comprising filtered frames, which are 2 low-frequency frames LLt and 2 high-frequency frames LHt in the example of FIG. 1.

Motion estimation and motion compensated temporal filtering are still repeated on the pair of odd LLto and even LLte low-frequency frames of the temporal subband T2, resulting in a temporal subband T3 of a third and last decomposition level comprising 1 low-frequency frame LLLt and 1 high-frequency frame LLHt.

Four-stage wavelet spatial filtering is applied on the frames LLLt and LLHt of the temporal subband T3 and the high-frequency frames of the other temporal subbands T1 and T2, i.e. the 2 LHt and the 4 Ht filtered frames. Each frame results in 4 spatio-temporal subbands comprising filtered frames sub-sampled by a factor 2 both in a horizontal and in a vertical direction.

At a next step, a spatial encoding of the coefficients of the frames of the spatio-temporal subbands is then performed, each spatio-temporal subband being encoded separately beginning from the low-frequency frame of the spatio-temporal subband of the last decomposition level. The motion vector fields are also encoded.

Finally, an output bitstream is formed on the basis of the encoded coefficients of the spatio-temporal subbands and of the encoded motion vector fields, the bits of said motion vector fields being sent as an overhead.

However, the encoding method according to the prior art has a number of disadvantages. First of all, the motion estimation and the motion compensated temporal filtering steps are implemented on full size frames. Therefore, these steps are computationally expensive and may cause a delay during encoding. Besides, motion vectors of the highest spatial resolution are encoded at each temporal level, which results in a quite high overhead. Moreover, during a decoding of the encoded bitstream at a lower spatial resolution, motion vectors of original resolution are used, which causes a not accurate motion compensated temporal reconstruction. The encoding method has also a low computational scalability.

### SUMMARY OF THE INVENTION

It is an object of the invention to propose an encoding method, which is computationally less expensive than the one of the prior art.

To this end, the encoding method in accordance with the invention is characterized in that it comprises the steps of:
dividing the sequence of frames into groups of input frames,
one level spatial wavelet-based filtering the frames of a group to generate a first spatial subband of a first decomposition level comprising low-low spatially filtered frames with reduced size compared to the input frames,
doing motion estimation on pairs of the low-low spatially filtered frames, resulting in a set of motion vector fields,
motion-compensated temporal wavelet-based filtering the low-low spatially filtered frames based on the set of motion vector fields, resulting in a first temporal subband of a first decomposition level comprising temporally filtered frames,
repeating the three preceding steps, the spatial filtering step being adapted to generate a first spatial subband of a second decomposition level on the basis of low frequency temporally filtered frames, the motion estimation and motion-compensated temporal filtering being applied to frames of said first spatial subband of the second decomposition level.

The encoding method in accordance with the invention proposes to combine and to alternate spatial and temporal wavelet-based filtering steps. As it will be seen later in the description, this combination simplifies the motion compensated temporal filtering step. As a consequence, the encoding method is computationally less expensive than the one of the prior art.

The present invention also relates to an encoding device implementing such a encoding method. It finally relates to a computer program product comprising program instructions for implementing said encoding method.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram showing an encoding method in accordance with the prior art, and

FIGS. 2A and 2B represent a block diagram of the encoding method in accordance with the invention.

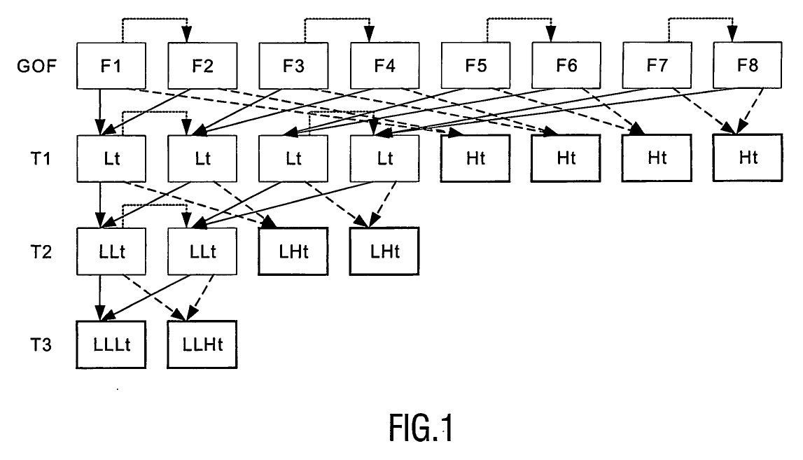

### DETAILED DESCRIPTION OF THE INVENTION

The present invention relates to a three-dimensional or 3D wavelet encoding method with motion compensation. Such an encoding method has been demonstrated to be an efficient technique for scalable video encoding applications. Said 3D compression or encoding method uses wavelet transform in both spatial and temporal domains. Conventional schemes for 3D wavelet encoding presume a separate execution of the wavelet-based spatial filtering and of the motion compensated wavelet-based temporal filtering.

The present invention proposes a modification of the conventional 3D scalable wavelet video encoding by combining and iteratively alternating spatial and temporal wavelet-based filtering steps. This modification simplifies the motion compensated temporal filtering step and provides a better balance between temporal and spatial scalabilities.

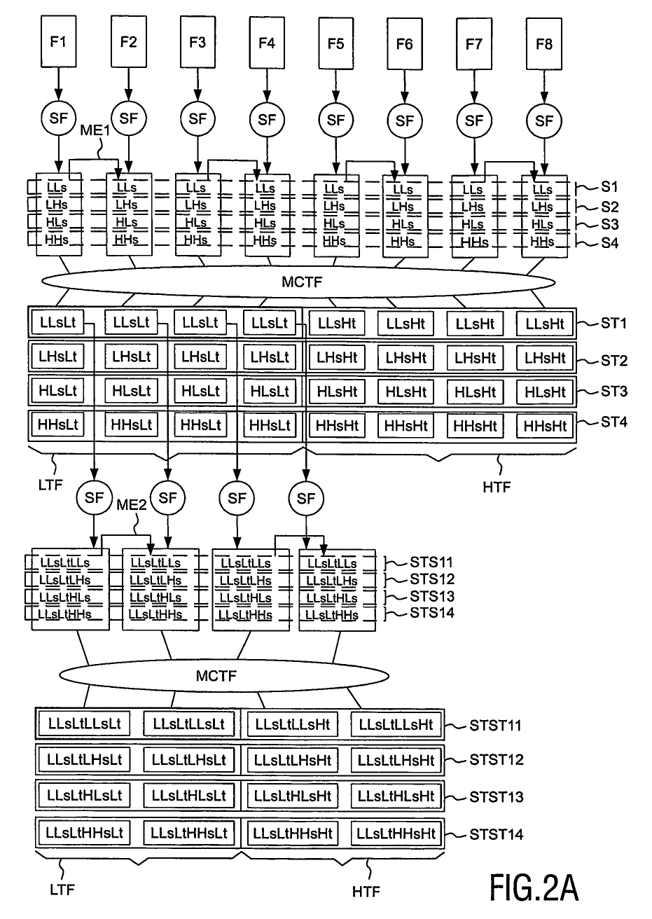

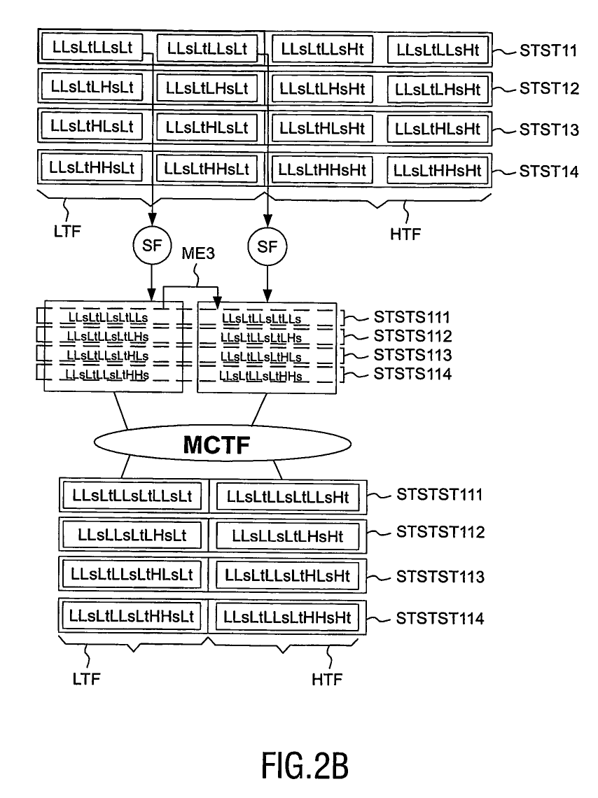

FIGS. 2A and 2B is a block diagram illustrating the encoding method in accordance with the invention.

It comprises a first step of dividing the sequence of frames into groups of N consecutive frames, where N is a power of 2, a frame having a size H×W. In the example depicted in the following description, the group of frames includes 8 frames F1 to F8.

Then it comprises a one level spatial filtering step SF of the frames of a group of frames. Said step is based on a wavelet transform and is adapted to generate 4 spatial subbands S1 to S4 of a first decomposition level. A first spatial subband S1 comprises N=8 spatially filtered low-low LLs frames, where s indicates the result of the wavelet transform in the spatial domain; a second spatial subband S2 comprises 8 spatially filtered low-high LHs frames; a third spatial subband S3 comprises 8 spatially filtered high-low HLs frames; and a fourth spatial subband S4 comprises 8 spatially filtered high-high HHs frames. Each spatially filtered frame has a size H/2×W/2.

At a next step, a motion estimation ME1 is performed on couples of consecutive low-low LLs frames of the first spatial subband S1, i.e. odd low-low frames LLso and even low-low frames LLse, resulting in a first set MV1 of motion vector fields comprising N/2=4 fields in our example.

Based on the set MV1 of motion vector fields thus obtained, a motion-compensated temporal filtering MCTF is implemented on the low-low LLs frames, resulting in a first temporal subband ST1 of a first decomposition level comprising N=8 frames, which are 4 low temporal frequency LLsLt frames and 4 high temporal frequency LLsHt frames, where t indicates the result of the wavelet transform in the temporal domain. Said temporal filtering step uses a lifting scheme adapted to deliver high-frequency wavelet coefficients and low-frequency coefficients on the basis of a prediction function P and of an update function U. For example, the prediction and update functions of the lifting scheme are based on the (4,4) Deslauriers-Dubuc wavelet transform such as:
LLsHt[n]=LLse[n]−(−LLso[n−1]+9LLso[n]+9LLso[n+1]−LLso[n+2])/16,
LLsLt[n]=LLso[n]+(−LLsHt[n−2]+9LLsHt[n−1]+9LLsHt[n]−LLsHt[n+1])/16.

As an option, the motion compensated temporal filtering MCTF step is applied to low-high LHs of the second S2 subband, to high-low HLs frames of the third S3 subband, and to high-high HHs frames of the fourth subband S4, re-using the first set MV1 of motion vector fields. It results in second ST2, third ST3 and fourth ST4 temporal subbands of a first decomposition level, which comprise 4 low temporal frequency LHsLt frames and 4 high temporal frequency LHsHt frames, 4 HLsLt frames and 4HLsHt frames, 4 HHsLt frames and 4 HHsHt frames, respectively. The temporal decorrelation of LHs, HLs, and HHs frames provides a better energy compaction at the cost of additionally required processing.

The sequence comprising the spatial filtering step, the motion estimation step and the motion compensated filtering step is then iterated until the subbands of the last decomposition level are received, i.e. only one low temporal frequency frame per temporal subband is left. Alternatively, said sequence of steps is iterated until a certain amount of computational resources are used. At each iteration, the inputs of the sequence of steps are couples of consecutive frames having the lowest frequency in both temporal and spatial domains.

With respect to the hereinabove described example, said iteration of sequence of steps comprises the followings steps.

First of all, a one-level spatial filtering step SF is applied to the low temporal frequency LTF frames LLsLt of the first temporal subband ST1 of the first decomposition level, resulting in 4 spatial subbands STS11 to STS14 of a second decomposition level. Each spatial subband comprises N/2=4 spatially filtered frames LLsLtLs or LLsLtLHs or LLsLtHLs or LLsLtHHs with size (H/4)×(W/4).

Then, a motion estimation step ME2 is performed on couples of consecutive filtered frames of the first spatial subband STS11 of the second decomposition level, said filtered frames LLsLtLLs having the lowest frequency in both temporal and spatial domains, resulting in a set MV2 of vector fields comprising N/4=2 fields.

Based on the set MV2 of motion vector fields, a motion-compensated temporal filtering MCTF as hereinabove described is applied to said LLsLtLLs filtered frames, resulting in a first temporal subband STST11 of a second decomposition level comprising N/2=4 temporally filtered frames, which are 2 LLsLtLLsLt and 2 LLsLtLLsHt.

Besides, the motion compensated temporal filtering MCTF step is optionally applied to LLsLtLHs, LLsLtHLs, and LLsLtHHs filtered frames, re-using the set MV2 of motion vector fields. This results in second STST12, third STST13 and fourth STST14 temporal subbands of a second decomposition level. Said subbands comprise 2 LLsLtLHsLt and 2 LLsLtLHsHt, 2 LLsLtHLsLt and 2 LLsLtHLsHt, 2 LLsLtHHsLt and 2 LLsLtHHsHt frames, respectively.

A one-level spatial filtering step SF is this time applied to the low temporal frequency frames LLsLtLLsLt of the first temporal subband STST1 1 of the second decomposition level, resulting in spatial subbands STSTS111 to STSTS114 of a third decomposition level. Each spatial subband comprises N/4=2 frames LLsLtLLsLtLLs or LLsLtLLsLtLHs or LLsLtLLsLtHLs or LLsLtLLsLtHHs with size (H/8)×(W/8).

Motion estimation ME3 is then performed on the couple of consecutive frames LLsLtLLsLtLLs of the first spatial subband of the third decomposition level, resulting in a motion vector field MV3.

Based on the motion vector field MV3, a motion-compensated temporal filtering MCTF is applied to LLsLtLLsLtLLs filtered frames, resulting in a first temporal subband STSTST111 of a third decomposition level comprising N/4=2 frames, which are LLsLtLLsLtLLsLt and LLsLtLLsLtLLsHt. Those frames comprise low-frequency data in both spatial and temporal domain, and therefore have to be encoded with highest priority, i.e. they are the first packets in a fmal bit-stream.

Besides, the motion compensated temporal filtering MCTF step is optionally applied to LLsLtLLsLtLHs, LLsLtLLsLtHLs, and LLsLtLLsLtHHs frames, re-using the motion vector field MV3, resulting in second STSTST112, third STSTST113 and fourth STSTST114 temporal subbands of a third decomposition level. Said subbands comprise LLsLtLLsLtLHsLt and LLsLtLLsLtLHsHt, LLsLtLLsLtHLsLt and LLsLtLLsLtHLsHt, LLsLtLLsLtHHsLt and LLsLtLLsLtHHsHt frames, respectively.

Independently of the iteration of the sequence of steps, a spatial filtering is applied to the high-temporal-frequency HTF frames LLsHt of the first temporal subband ST1 of the first decomposition level. Contrary to the spatial filtering of the low-temporal-frequency frames LLsLt, where only one level of spatial filtering is implemented, the spatial filtering of LLsHt frames is pyramidal, i.e. multi-layer, up to the coarsest spatial decomposition level, i.e. the smallest spatial resolution.

Alternatively, spatial filtering can be applied to the low-temporal-frequency LTF frames LHsLt, HLsLt, and HHsLt of the second ST2, third ST3 and fourth ST4 temporal subbands of the first decomposition level, respectively, depending on the type of the wavelet filters used. It results in spatial subbands STS21 to STS24, STS31 to STS34 and STS41 to STS44, respectively.

According to the main embodiment of the invention, the spatial subbands received after spatial filtering of LLsHt frames along with the second ST2, third ST3, and fourth ST4 subbands, provided that they are not temporally filtered, will be encoded to form the final bit-stream. In such an embodiment, the number of spatial decomposition levels of LLsHt frames is by one lower than the total number of spatial filtering implemented over the low-low subbands during encoding. For example in FIG. 2A and 2B, spatial filtering is implemented 3 times, i.e. 3 levels of spatial resolution will be received in total. In this case, the LLsHt frames of the ST1 subband is spatially filtered with 2 spatial decomposition levels, and the LLsLtLLsHt frames of the STST1 subband is spatially filtered with one decomposition level. In a more general way, the number of spatial decomposition levels according to the pyramidal spatial filtering at a current temporal decomposition level is equal to the total number of spatial decomposition levels minus the current spatial decomposition level. The pyramidal spatial analysis of LLsHt and LLsLtLLsHt frames is, for example, the spatial decomposition based on the SPIHT compression principle and described in the paper entitled “A fully scalable 3D subband video codec” by V. Bottreau, M. Bénetiére, B. Pesquet-Popescu and B. Felts, Proceedings of IEEE International Conference on Image Processing, ICIP2001, vol. 2, pp. 1017-1020, Thessaloniki, Greece, Oct. 7-10, 2001.

According to another embodiment of the invention, the motion compensated temporal filtering MCTF step comprises a delta low-pass temporal filtering sub-step. This means that one of the two consecutive frames, which takes part in temporal filtering MCTF after motion estimation will be just copied into a resulted low temporal frequency frame, and only a high-pass temporal filtering will be implemented. In this case, the low temporal frequency frame does not comprise temporally average information, but just one of the frame that took part in the temporal filtering MCTF. This approach is similar to I and B frames structure from MPEG-like coders. Decoding a stream encoded in such a way at a low temporal resolution will result in a sequence comprising skipped frames, but no temporally averaged frames. In other words, instead of low-pass temporal filtering like in the prior art schemes, one of the frames is just regarded as a resulted low temporal frequency frame.

Once the filtering steps are performed, the encoding method in accordance with the invention comprises a step of quantizing and entropy coding the wavelet coefficients of the filtered frames of predetermined subbands, i.e.:
frames of the subbands of the last temporal decomposition level (the STSTST111 to STST114 subbands in our example),
high temporal frequency HTF frames of spatio-temporal subbands of previous temporal decomposition levels (the frames resulting from the spatial filtering of LLsHt frames of ST1 subband and of LLsLtLLSHt frames of STST1 subband in our example),
frames of temporal subbands of previous temporal decomposition levels (the frames resulting from the spatial filtering of the frames of STST12 to STST14 and ST2 to ST4 subbands in our example).
   This coding step is based on, for example, embedded zero-tree block coding EZBC.

The encoding method in accordance with the invention also comprises a step of encoding the motion vector fields based on, for example, lossless differential pulse code modulation DPCM and/or adaptive arithmetic coding. It is to be noted that the motion vectors have a resolution that decreases with the number of decomposition level. As a consequence, the overhead of encoded motion vectors is much smaller than in the prior art schemes.

It finally comprises a step of forming the final bit-stream on the basis of the encoded coefficient of the spatio-temporal subbands and of the encoded motion vector fields, the bits of said motion vector fields being sent as overhead.

During encoding the received spatio-temporal subbands are embedded in the final bit-stream with different priority levels. An example of such a bit-stream, from the highest priority level to the lowest priority level is the following:
low temporal frequency frames LTF of STSTST111-114 subbands,
high temporal frequency frames HTF of STSTST111-114 subbands,
low temporal frequency frames LTF of STST12-14 subbands,
high temporal frequency frames HTF of STST11-14 subbands,
low temporal frequency frames LTF of ST2-4 subbands, and
high temporal frequency frames HTF of ST1-4 subbands.
   As another example, where the temporal scalability has to be emphasized during encoding, the low temporal frequency frames LTF of all spatial resolutions are encoded first followed by the high temporal frequency frames HTF.

The number of spatial and temporal decompositions levels depends on the computational resources (e.g. processing power, memory, delay allowed) at the encoder side and may be adjusted dynamically (i.e. the decomposition is stopped as soon as a limit of processing resources is reached). Contrary to the prior art method, where the complete temporal decomposition should be first implemented followed by the spatial decomposition of the received temporal subbands, the proposed encoding method is adapted to stop the decomposition virtually at any moment after the first temporal decomposition level has been obtained and to transmit both temporally and spatially filtered frames thus obtained. As a consequence, computation scalability is provided.

The encoding method in accordance with the invention can be implemented by means of items of hardware or software, or both. Said hardware or software items can be implemented in several manners, such as by means of wired electronic circuits or by means of an integrated circuit that is suitable programmed, respectively. The integrated circuit can be contained in an encoder. The integrated circuit comprises a set of instructions. Thus, said set of instructions contained, for example, in an encoder memory may cause the encoder to carry out the different steps of the motion estimation method. The set of instructions may be loaded into the programming memory by reading a data carrier such as, for example, a disk. A service provider can also make the set of instructions available via a communication network such as, for example, the Internet.

Any reference sign in the following claims should not be construed as limiting the claim. It will be obvious that the use of the verb “to comprise” and its conjugations do not exclude the presence of any other steps or elements besides those defined in any claim. The word “a” or “an” preceding an element or step does not exclude the presence of a plurality of such elements or steps.

1. A method of encoding a sequence of frames comprising the steps of:
dividing the sequence of frames into groups of input frames (F1-F8),
one level spatial wavelet-based filtering (SF) the frames of a group to generate a first spatial subband (S1) of a first decomposition level comprising low-low spatially filtered frames (LLs) with reduced size compared to the input frames,
doing motion estimation (ME1) on pairs of the low-low spatially filtered frames (LLs), resulting in a set of motion vector fields,
motion-compensated temporal wavelet-based filtering (MCTF) the low-low spatially filtered frames (LLs) based on the set of motion vector fields, resulting in a first temporal subband (ST1) of a first decomposition level comprising temporally filtered frames (LLsLt-LLsHt),
repeating the three preceding steps, the spatial filtering step being adapted to generate a first spatial subband of a second decomposition level (STS11) on the basis of low frequency temporally filtered frames (LLsLt), the motion estimation and motion-compensated temporal filtering being applied to frames of said first spatial subband of the second decomposition level.

2. An encoding method as claimed in claim 1, wherein a sequence comprising the spatial filtering step, the motion estimation step and the motion compensated temporal filtering step is iterated until the temporal subband of a predetermined decomposition level only comprises one low temporal frequency frame, inputs for the sequence of steps being, at each iteration, temporally filtered frames (LLsLtLLsLt) having the lowest frequency in both temporal and spatial domains.

3. An encoding method as claimed in claim 1, wherein a sequence comprising the spatial filtering step, the motion estimation step and the motion compensated temporal filtering step is iterated until a certain amount of computational resources are used, inputs for the sequence of steps being, at each iteration, frames having the lowest frequency in both temporal and spatial domains.

4. An encoding method as claimed in claim 1, wherein the one level spatial filtering step (SF) is adapted to deliver at least one other spatial subband (S2-S4, STS12-STS14) of a current decomposition level, said method further comprising a step of motion-compensated temporal filtering frames of the at least one other spatial subband, re-using a set of motion vector feilds of the first spatial subband corresponding to the current composition level, and resulting in at least one other temporal subband (ST2-ST4, STST12-STST44) of said current decomposition level.

5. An encoding method as claimed in claim 4, further comprising a step of pyramidal spatial filtering of spatially filtered frames of the at least one other temporal subband (STS12-STS14, STSTS112-STSTS114) of the current decomposition level.

6. An encoding method as claimed in claim 1, further comprising a step of pyramidal spatial filtering of spatial low-frequency temporal high-frequency frames (LLsHt, LLsLtLLsHt) of the first temporal subband (ST1, STST11) of a current decomposition level.

7. An encoding method as claimed in claim 5, wherein the number of spatial decomposition levels in the pyramidal spatial filtering step at a current decomposition level is equal to a total number of spatial decomposition levels minus the current decomposition level.

8. A device for encoding a sequence of frames comprising:
means for dividing the sequence of frames into groups of input frames (F1-F8),
means for one level wavelet-based spatial filtering (SF) the frames of a group to generate a first spatial subband (S1) of a first decomposition level comprising low-low spatially filtered frames (LLs) with reduced size compared to the input frames,
means for doing motion estimation (ME1) on pairs of the low-low spatially filtered frames (LLs), resulting in a set of motion vector fields,
means for motion-compensated temporal wavelet-based filtering (MCTF) the low-low spatially filtered frames (LLs) based on the set of motion vector fields, resulting in a first temporal subband (ST1) of a first decomposition level comprising temporally filtered frames (LLsLt-LLsHt),
the three preceding means being configured such that the spatial filtering means are adapted to generate a first spatial subband of a second decomposition level (STS11) on the basis of low frequency temporally filtered frames (LLsLt), and that the motion estimation and motion-compensated temporal filtering means are adapted to receive frames of said first spatial subband of the second decomposition level.

9. A computer program product comprising program instructions for implementing, when said program is executed by a processor, an encoding method as claimed in claim 1.
